(19) United States
(12) Patent Application Publication
(10) Pub. No.: US 2026/0260088 A1
(43) Pub. Date: Sep. 3, 2026

(54) RADIO FREQUENCY IDENTIFICATION TAG ANTENNA FOR METALLIC OBJECTS

(71) Applicant: Nanyang Technological University, Singapore (SG)

(72) Inventors: Rui XU, Singapore (SG); Zhongxiang SHEN, Singapore (SG); Jingyuan TAN, Herzogenaurach (DE); Benaya CHRISTO, Herzogenaurach (DE); Boon Siew HAN, Herzogenaurach (DE)

(21) Appl. No.: 18/881,720

(22) PCT Filed: Jul. 24, 2023
(86) PCT No.: PCT/SG2023/050512

§ 371 Date: Jan. 6, 2025

(30) Foreign Application Priority Data
Jul. 27, 2022 (SG) 10202250603J

(51) Int. Cl. G06K 19/077; H01Q 1/22; H01Q 9/16

(52) U.S. Cl. CPC G06K 19/07773; H01Q 1/2208; H01Q 9/16

(57) ABSTRACT

An RFID tag antenna for mounting on a metallic object comprises: a dielectric substrate having a first surface and a second surface opposing the first surface; a conductive layer provided on the first surface that is configured to be attached to a surface of the metallic object; an integrated circuit mounted on the second surface of the dielectric substrate; an antenna structure formed on the second surface of the dielectric substrate; a T-match structure formed on the second surface of the dielectric substrate electrically coupling the antenna structure to the integrated circuit; a first via pin passing through the dielectric substrate and electrically connecting a first point on the antenna structure with a corresponding first point on the conductive layer; and a second via pin passing through the dielectric substrate and electrically connecting a second point on the antenna structure with a corresponding second point on the conductive layer.

### TECHNICAL FIELD

The present disclosure relates to radio frequency identification (RFID) tags and in particular RFID tag antennas for mounting on metallic objects.

### BACKGROUND

Nowadays, the rapid advancement of radio frequency identification (RFID) technology has attracted much attention. Because of the long-range identification ability of RFID tags in the ultra-high frequency (UHF) band, they have been widely implemented for supply chain management, inventory checking, assets tracking, gate automation, etc.

However, many applications require RFID tags to be mounted on electrically conductive metallic objects, such as motor vehicle, cylinders, containers, weapons, and equipment and so on. When ordinary UHF tags are placed on a metal surface, their reading range is severely degraded owing to impedance mismatching, lower radiation efficiency, and deteriorated directivity. Therefore, so-called anti-metal tags must be specifically designed to overcome these challenges.

Previously, tags have been proposed for the UHF RFID band based on a microstrip-patch-type antenna that has its own ground plane. However, this results in a very large antenna size, having a resonance length is close to one-quarter wavelength, making it difficult to mount on a small metal object. Many dipole-like and folded tags have been designed for miniaturization, but the size of the tag antenna is still large, and this kind of antenna is composed of multiple layers, resulting in a weak structure. In some special compact metal platforms, such as metal cylinders and bearings, the tag antenna is required to be conformally designed. Due to their large size and unstable structure, the above designs are difficult to implement with conformal design.

### SUMMARY

According to an aspect of the present disclosure, an RFID tag antenna for mounting on a metallic object is provided. The RFID tag antenna comprises: a dielectric substrate having a first surface and a second surface opposing the first surface; a conductive layer provided on the first surface of the dielectric substrate, the conductive layer being configured to be attached to a surface of the metallic object; an integrated circuit mounted on the second surface of the dielectric substrate; an antenna structure formed on the second surface of the dielectric substrate; a T-match structure formed on the second surface of the dielectric substrate, the T-match structure electrically coupling the antenna structure to the integrated circuit; a first via pin passing through the dielectric substrate and electrically connecting a first point on the antenna structure with a corresponding first point on the conductive layer; and a second via pin passing through the dielectric substrate and electrically connecting a second point on the antenna structure with a corresponding second point on the conductive layer.

The provision of the conductive layer on the first surface of the dielectric substrate allows the RFID tag antenna to function when mounted on metallic objects.

In an embodiment, the dielectric substrate is formed from a flexible material. This allows the RFID tag antenna to be mounted on both planar metallic objects and curved metallic objects such as cylindrical bearings.

In an embodiment, the T-match structure is configured to conjugate match an impedance of the antenna structure with an impedance of the integrated circuit. The T-match structure may be formed in a meander pattern. This allows the length of the T-match structure to be varied without impacting the overall dimensions of the RFID tag antenna. The length of the meander structure may be selected to conjugate match the impedance of the antenna structure with the impedance of the integrated circuit.

In an embodiment, the antenna structure comprises two antenna parts arranged in a dipole structure. Each antenna part may comprise a first leg portion and a second leg portion.

In an embodiment, a resonant length of each antenna part corresponds to a length from an end of the first leg portion to an end of the second leg portion. The end of the first leg portion of a first antenna part may correspond to the first point on the antenna structure and the end of the first leg portion of a second antenna part may correspond to the second point on the antenna structure.

In an embodiment, the second leg portion of each antenna part has a meander structure. This configuration allows the length of the second leg portion to be increased without impacting the overall dimensions of the RFID tag antenna.

In an embodiment the dielectric substrate is rectangular. The first point on the antenna structure and the second point on the antenna structure may correspond to diagonally opposite corners of the dielectric substrate.

### BRIEF DESCRIPTION OF THE DRAWINGS

In the following, embodiments of the present invention will be described as non-limiting examples with reference to the accompanying drawings in which:

FIG. 1A shows a cross-sectional view of an RFID tag antenna according to an embodiment of the present invention;

FIG. 1B shows a perspective view of an RFID tag antenna according to an embodiment of the present invention;

FIG. 1C shows a top down view of an RFID tag antenna according to an embodiment of the present invention;

FIG. 2 shows an equivalent circuit of an RFID tag antenna according to an embodiment of the present invention;

FIG. 3 shows the results of a comparison of input impedance between an RFID tag antenna according to an embodiment of the present invention and a simulation using High Frequency Simulation Software (HFSS) based on the equivalent circuit shown in FIG. 2;

FIG. 4 shows simulated and measured input impedance against frequency for an RFID tag antenna according to an embodiment of the present invention;

FIG. 5 shows simulated and measured power reflection coefficients for an RFID tag antenna according to an embodiment of the present invention;

FIG. 6A shows simulated and measured reading patterns in the E-plane for an RFID tag antenna according to an embodiment of the present invention;

FIG. 6B shows simulated and measured reading patterns in the H-plane for an RFID tag antenna according to an embodiment of the present invention;

FIG. 7 shows simulated and measured maximum reading distance against frequency for an RFID tag antenna according to an embodiment of the present invention;

FIG. 8A to FIG. 8E show an RFID tag antenna according to an embodiment of the present invention mounted on metallic objects;

FIG. 9 shows a resonant length of RFID tag antenna according to an embodiment of the present invention;

FIG. 10 shows a T-matching impedance matching network used in embodiments of the present invention;

FIG. 11 shows the impedances of the tag antenna and tag chip of an RFID tag antenna according to an embodiment of the present invention; and

FIG. 12 is a flow chart showing a method of determining the design parameters of an RFID tag antenna according to an embodiment of the present invention.

### DETAILED DESCRIPTION

The present disclosure provides an RFID tag antenna which can be on metal platforms with different shapes and size, such as planar metal plate, metal cylinders, containers, bearings and so on.

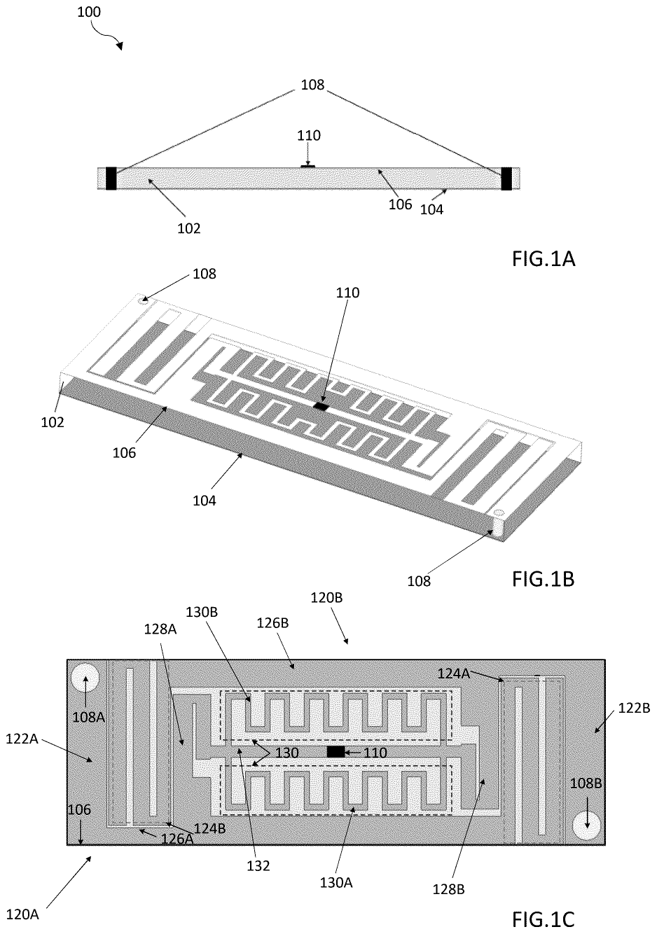

FIG. 1A to FIG. 1C show an RFID tag antenna according to an embodiment of the present invention. FIG. 1A is a cross-sectional view, FIG. 1B is a perspective view and FIG. 1C is a top view.

In the embodiment shown in FIG. 1A to FIG. 1C, the RFID tag antenna 100 is designed to operate in US UHF RFID band applications (902-928 MHz). However, it will be appreciated that the dimensions of the RFID tag antenna may be adjusted to operate in other RFID frequency bands.

As shown in FIG. 1A, the RFID tag antenna 100 comprises a dielectric substrate 102. In order to allow the RFID tag antenna 100 to operate in both planar metal platforms and curved metal platforms, the dielectric substrate 102 is formed from a flexible material. For example, the material Arlon AD430 may be selected. Alternatively, materials with similar or close dielectric constants and loss tangents including but not limited to Arlon AD450 and Rogers TMM4 may be selected. In one exemplary embodiment, the dimensions of the dielectric substrate 102 are 10 mm×30 mm×1.5 mm.

The RFID tag antenna 100 is fabricated with printed circuit board (PCB) technology. A lower surface conductive coating is applied to the lower surface of the dielectric substrate 102. The lower surface conductive coating 104 covers the lower surface of the dielectric substrate 102. An upper surface conductive coating 106 is applied to the upper surface of the dielectric substrate 102 and the upper surface conductive coating forms antenna and T-match structures which are described in more detail below. Via pins 108 pass through the dielectric substrate 102 and form conductive connections between the lower surface conductive coating 104 and the upper surface conductive coating 106. An integrated circuit chip 110 is mounted on the upper surface of the dielectric substrate 102 and connected to parts of the upper surface conductive coating 106. The integrated circuit 110 is a RFID tag integrated circuit such as an Alien Higgs 9 (AH-9) tag chip.

As shown in FIG. 1B, the integrated circuit chip 110 is mounted at the center of the upper surface of the dielectric substrate 102. The RFID tag antenna 100 is rectangular and via pins 108 are located at diagonally opposite corners of the RFID tag antenna 100 (in FIG. 1B, the top left corner and the bottom right corner). The via pins 108 connect the upper surface conductive coating 106 to the lower surface conductive coating 104.

FIG. 1C is a top view of the RFID tag antenna 100 showing the layout of the upper surface conductive coating 106. The upper surface conductive coating 106 forms a dipole like structure which is rotationally symmetric around the integrated circuit 110 at the center of the upper surface. The layout of the surface conductive coating 106 may be considered to be made up of a first radiator portion 120A, a second radiator portion 120B and a T-match portion 130. The first radiator portion 120A and the second radiator portion 120B may be considered as two antenna parts arranged in a dipole structure with the first radiator portion corresponding to a first antenna part and the second radiator portion corresponding to a second antenna part. As mentioned above, the first radiator portion 120A and the second radiator portion 120B are rotationally symmetric by 180 degrees around the integrated circuit 110 at the center of the upper surface. The first radiator portion 120A comprises a first leg portion 122A which runs from the top left hand corner of the upper surface as shown in FIG. 1C where there is a connection with one of the via pins 108A, across the width of the upper surface to the bottom left corner of the upper surface. A second leg portion 124A of the first radiator portion 120A is located close to the right hand edge of the upper surface, but separated from the right hand edge of the upper surface by the second radiator portion 120B. The second leg portion 124A has a meander pattern. This meander pattern allows the effective length of the second leg portion 124A to be increased without increasing overall dimensions of the RFID tag antenna 100. The first leg portion 122A and the second leg portion 124A of the first radiator portion 120A are connected by a central portion 126A of the first radiator portion 120A which runs along the bottom edge of the upper surface. A coupling portion 128A of the first radiator portion 120A runs from the central portion 126A of the first radiator portion 120A upwards and connects the first radiator portion 120A to the T-match portion 130.

Similarly, the second radiator portion 120B comprises a first leg portion 122B which runs from the bottom right corner of the upper surface where there is a connection with the other one of the via pins 108B. The first leg portion 122B of the second radiator portion 120B runs from the bottom right corner to the top right corner of the upper surface. A second leg portion 124B of the second radiator portion 120B is located close to the left hand edge of the upper surface, but separated from the edge by the first leg portion 122A of the first radiator portion 120A. The second leg portion 124B has a meander pattern. This meander pattern allows the effective length of the second leg portion 124B to be increased without increasing overall dimensions of the RFID tag antenna 100. The first leg portion 122B and the second leg portion 124B of the second radiator portion 120B are connected by a central portion 126B of the second radiator portion 120B which runs along the top edge of the upper surface. A coupling portion 128B of the second radiator portion 120B runs from the central portion 126B of the second radiator portion 120B downwards and connects the first radiator portion 120B to the T-match portion 130.

The T-match portion 130 comprises meandering paths 130A and 130B which are connected in parallel between the coupling portion 128A of the first radiator portion 120A and the coupling portion 128B of the second radiator portion 120B. A conductive path 132 is connected in parallel to both the meandering paths 130A, 130B which connect the integrated circuit 110 to each of the coupling portion 128A of the first radiator portion 120A and the coupling portion 128B of the second radiator portion 120B.

The two shorting via pins 108 are adopted to connect the ground plane and makes this dipole-type tag become planar inverted-F antenna (PIFA), thereby reducing the tag size. The meander lines further reduce the tag size.

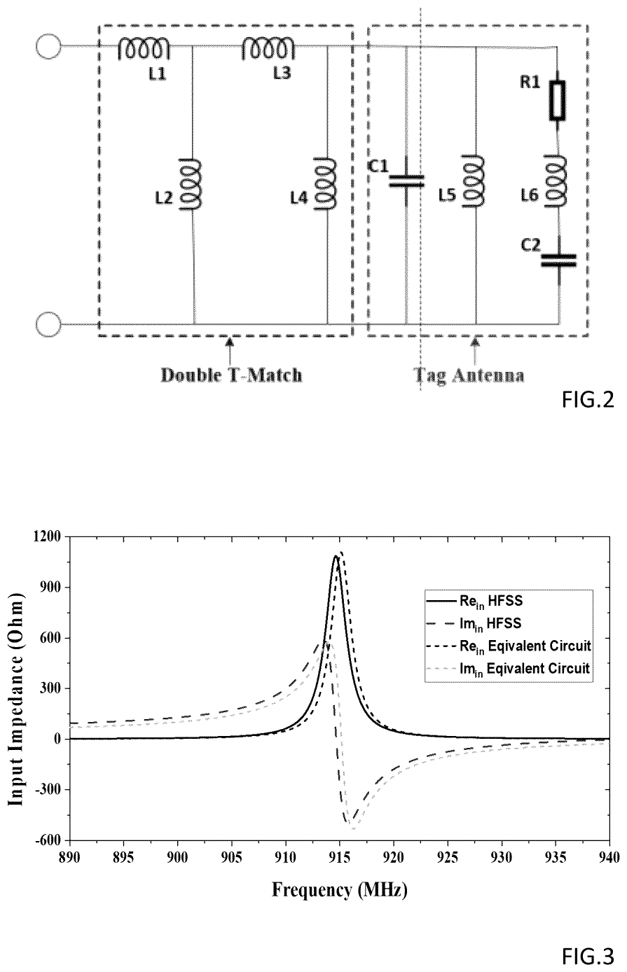

FIG. 2 shows an equivalent circuit of an RFID tag antenna according to an embodiment of the present invention. As shown in FIG. 2, the T-match portion 130 may be considered to be a double T-match circuit comprising four inductors L1, L2, L3 and L4, with two inductors L1 and L3 connected in series to one of the inputs to the integrated circuit and two inductors L2 and L4 connected in parallel across the inputs of the integrated circuit. The tag antenna which is formed from the first radiator portion 120A and the second radiator portion 120B described above with reference to FIG. 1C may be considered to have three parallel connections: a capacitor C1 making up the first connection, an inductor L5 making up the second connection and a capacitor C2 connected in series with an inductor L6 and a resistor R1 making up the third connection.

FIG. 3 shows the results of a comparison of input impedance between an RFID tag antenna according to an embodiment of the present invention and a simulation using High Frequency Simulation Software (HFSS) based on the equivalent circuit shown in FIG. 2.

The detailed values of the equivalent circuit were taken as: L1=L3=1.0 nH, L2=L4=12.85 nH, L5=4.0 nH, L6=12.9 nH, C1=2.0 pF, C2=1.9 pF, R1=0.25 ohm. As shown in FIG. 3, the curves are found to agree very well with their simulated results. The impedance for equivalent circuit is found to be 8.0+j190.2 at the tag resonance of 912.5 MHz, which is very close to the HFSS results of (9.0+j192.4) at 912.5 MHz.

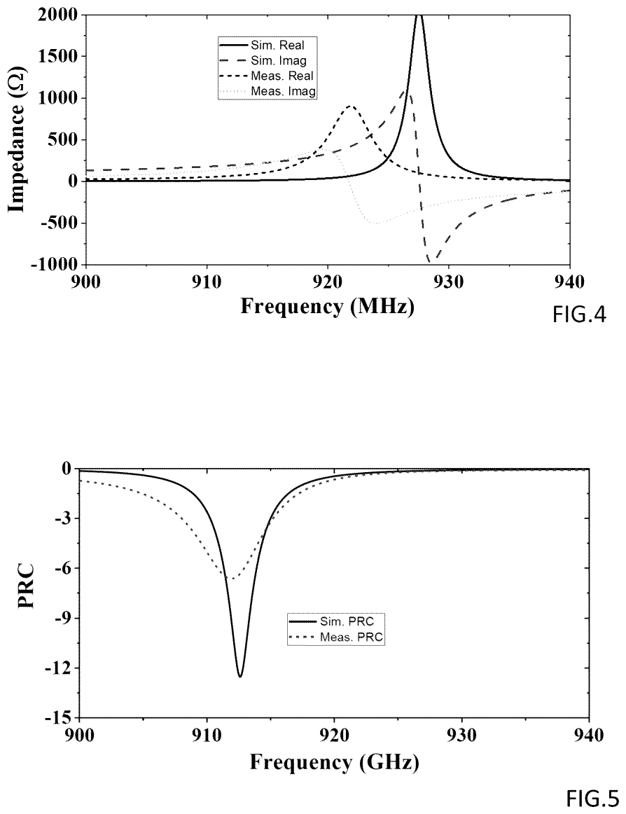

FIG. 4 shows simulated and measured input impedance against frequency for an RFID tag antenna according to an embodiment of the present invention. A differential probe method was used to measure the input impedance of the proposed tag antenna. The measured input impedance (real and imaginary parts) of this tag, which is illustrated in FIG. 4, slightly shifts to a lower frequency. The measured value of real part is bigger than the simulated one. As shown in FIG. 4, the value of imaginary part does not change greatly between the measured results and the simulation.

FIG. 5 shows simulated and measured power reflection coefficients for an RFID tag antenna according to an embodiment of the present invention. As can be seen in FIG. 5, the final measured center operating frequency of power reflection coefficients (PRC) moves to 911.5 MHz.

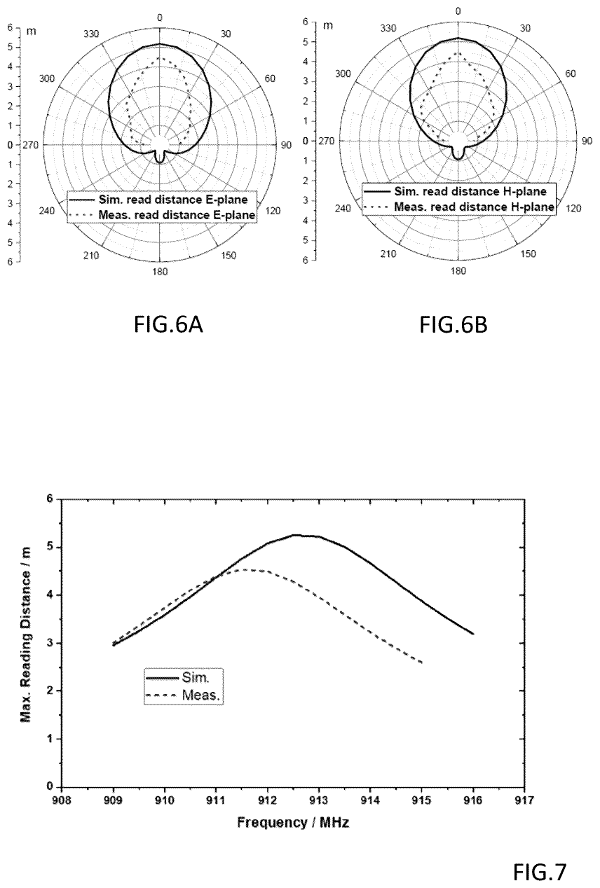

FIG. 6A shows simulated and measured reading patterns in the E-plane for an RFID tag antenna according to an embodiment of the present invention. FIG. 6B shows simulated and measured reading patterns in the H-plane for an RFID tag antenna according to an embodiment of the present invention.

To obtain the results shown in FIG. 6A and FIG. 6B, the tag was placed above a 15×15 cm² metal plate. It can be found that the maximum reading distance in both E-plane and H-plane is shorter than the simulation, which is mainly caused by the poor matching. Actually, the simulated maximum gain of proposed tag is −7.7 dB.

FIG. 7 shows simulated and measured maximum reading distance against frequency for an RFID tag antenna according to an embodiment of the present invention. As shown in FIG. 7, the operating frequency shifts about 1 MHz to lower frequency in the measured results compared with the simulated results.

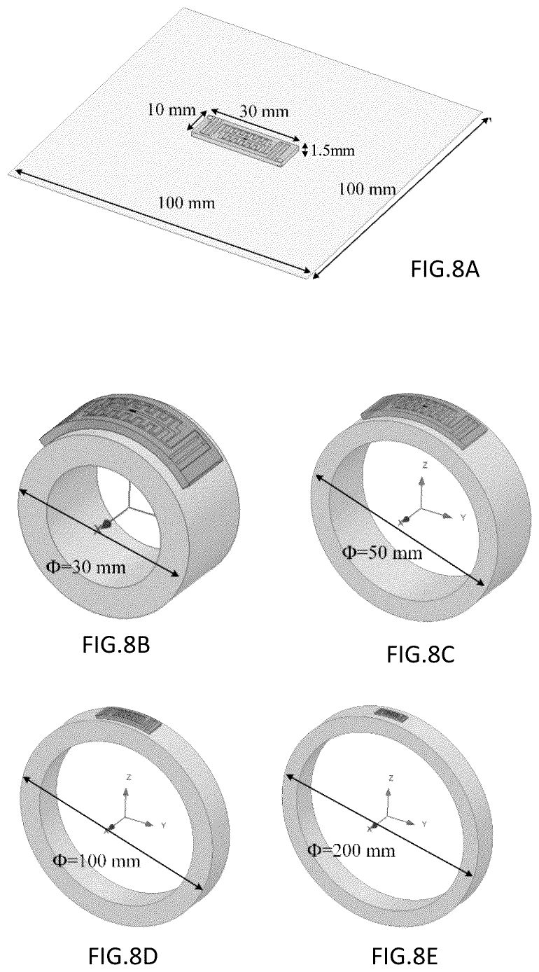

FIG. 8A to FIG. 8E show an RFID tag antenna according to an embodiment of the present invention mounted on metallic objects.

FIG. 8A shows the RFID tag antenna mounted on a planar metallic object which is 100 mm×100 mm. As shown in FIG. 8A, the RFID tag antenna has dimensions of 10 mm×30 mm×1.5 mm.

FIG. 81 shows the RFID tag antenna mounted on a cylindrical bearing having a diameter of 30 mm.

FIG. 8C shows the RFID tag antenna mounted on a cylindrical bearing having a diameter of 50 mm.

FIG. 8D shows the RFID tag antenna mounted on a cylindrical bearing having a diameter of 100 mm.

FIG. 8E shows the RFID tag antenna mounted on a cylindrical bearing having a diameter of 200 mm.

As shown in FIG. 8A to FIG. 8E, since the dielectric substrate is formed from a flexible material and therefore the RFID tag antenna itself is flexible, the RFID tag antenna can be placed conformally on some bearings with different diameters and well as on planar metallic objects. Because the designed RFID tag antenna has a highly miniaturized size, it can still work well despite the small size of the various conformal platforms.

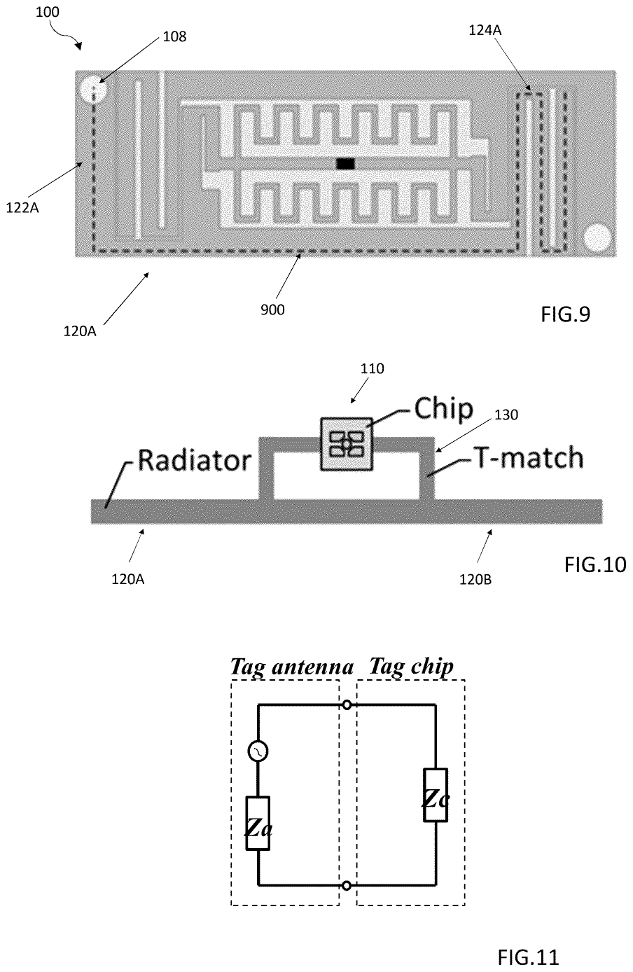

FIG. 9 shows a resonant length of RFID tag antenna according to an embodiment of the present invention. As shown in FIG. 9, the resonant length is the length of the first radiator portion 120A (which is equal to the length of the second radiator portion). The length runs from the end of the first leg portion 122A which corresponds to one of the via pins 108 to the end of the second leg portion 124A.

In general, the resonant length of an antenna is about half wavelength. Short pin loading means that adding the via pins 108 to the PIFA antenna structure can effectively reduce the effective length of the antenna. By reducing the resonance length to about a quarter wavelength, the antenna can achieve resonance at UHF frequencies. This approach helps to reduce the overall size of the tag while maintaining proper resonance. Thus, the resonant length 900 shown in FIG. 9 corresponds to a quarter of the resonant wavelength. It is noted that the meander pattern of the second leg portion 124A allows the RFID tag antenna can be further miniaturized.

FIG. 10 shows a T-matching impedance matching network. As shown in FIG. 10, the RFID tag antenna may be considered to be the integrated circuit 110 chip connected to a radiator (made up of the first radiator portion 120A and the second radiator portion 120B) by the T-match network 130.

T-Matching is an impedance matching network that comprises a T-shaped structure connected to the feed line of the tag antenna. The component values can be determined using the following equations:

$$L = \frac{1}{2 π f \sqrt{{C}_{in} \times {C}_{out}}}$$

$$C = \frac{1}{4 {π}^{2} {f}^{2} {LZ}_{in}}$$

Where L is the inductor value, C is the Capacitor value, Cᵢₙ and Cₒᵤₜ are the input and output capacitances of the tag antenna, respectively. Zᵢₙ is the desired input impedance of the tag antenna and f is the operating frequency. The actual component values may need to be adjusted or fine-tuned through simulation or experimental iterations.

FIG. 11 shows the impedances of the tag antenna and tag chip. As shown in FIG. 11, the tag antenna has an impedance Zₐ:

$${Z}_{a} = {R}_{a} + {jX}_{a}$$

and the tag chip has an impedance Zₑ.

$${Z}_{c} = {R}_{c} + {jX}_{c}$$

In order for the maximum power transfer, the complex conjugates of the impedances should be matched:

$${Z}_{a} = {Z}_{c}^{*}$$

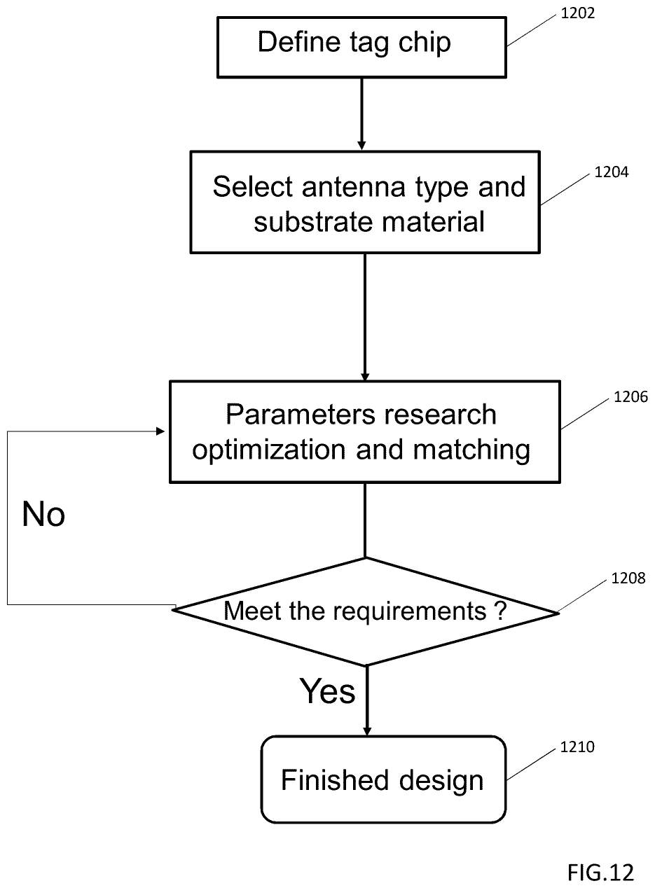

FIG. 12 is a flow chart showing a method of determining the design parameters of an RFID tag antenna according to an embodiment of the present invention.

Initially, in step 1202, the tag chip is selected and from this, the input impedance of the tag chip is known. In step 1204, the antenna type and substrate material are selected. Then, in step 1206, parameters are researched and optimized. This step may involve adjusting the length of the T-match structure to adjust the input impedance of the antenna to match the impedance of the integrated circuit chip. In order to realize the maximum energy transmission between tag and chip, conjugate matching is adopted. Therefore, the input impedance of the antenna should also be adjusted when changing the chip. As shown in FIG. 12, the parameters and optimized and in step 1208 checks are carried out whether the impedance matching requirements are met. If the requirements are met, then the design is finalized in step 1210. If not, the method returns to step 1206 and further optimization is carried out.

As described above, present disclosure provides a highly miniaturized UHF RFID tag antenna with meander line structure for tagging small metallic objects. In an example embodiment the total volume is only 10 mm×30 mm×1.5 mm. This tag can be used for planar platforms as well as platforms requiring conformal, such as metal cylinders and bearings.

Further, the present disclosure provides a very simple and compact folded dipole structure has been designed for anti-metal UHF tag antenna. The proposed tag is able to achieve a large reading distance of more than 4 m. The proposed tag antenna has a very thin thickness and can be easily made to be flexible conformal to some curved surfaces.

Whilst the foregoing description has described exemplary embodiments, it will be understood by those skilled in the art that many variations of the embodiments can be made within the scope and spirit of the present invention.

1. An RFID tag antenna for mounting on a metallic object, the RFID tag antenna comprising:
a dielectric substrate having a first surface and a second surface opposing the first surface;
a conductive layer provided on the first surface of the dielectric substrate, the conductive layer being configured to be attached to a surface of the metallic object;
an integrated circuit mounted on the second surface of the dielectric substrate;
an antenna structure formed on the second surface of the dielectric substrate;
a T-match structure formed on the second surface of the dielectric substrate, the T-match structure electrically coupling the antenna structure to the integrated circuit;
a first via pin passing through the dielectric substrate and electrically connecting a first point on the antenna structure with a corresponding first point on the conductive layer; and
a second via pin passing through the dielectric substrate and electrically connecting a second point on the antenna structure with a corresponding second point on the conductive layer.

2. The RFID tag antenna according to claim 1, wherein the dielectric substrate is formed from a flexible material.

3. The RFID tag antenna according to claim 1, wherein the T-match structure is configured to conjugate match an impedance of the antenna structure with an impedance of the integrated circuit.

4. The RFID tag antenna according to claim 3, wherein the T-match structure is formed in a meander pattern.

5. The RFID tag antenna according to claim 4, wherein a length of the meander structure is selected to conjugate match the impedance of the antenna structure with the impedance of the integrated circuit.

6. The RFID tag antenna according to claim 1, wherein the antenna structure comprises two antenna parts arranged in a dipole structure.

7. The RFID tag antenna according to claim 6, wherein each antenna part comprises a first leg portion and a second leg portion.

8. The RFID tag antenna according to claim 7, wherein a resonant length of each antenna part corresponds to a length from an end of the first leg portion to an end of the second leg portion.

9. The RFID tag antenna according to claim 8, wherein the end of the first leg portion of a first antenna part corresponds to the first point on the antenna structure and the end of the first leg portion of a second antenna part corresponds to the second point on the antenna structure.

10. The RFID tag according to claim 7, wherein the second leg portion of each antenna part has a meander structure.

11. The RFID tag antenna according to claim 1, wherein the dielectric substrate is rectangular.

12. The RFID tag antenna according to claim 11, wherein the first point on the antenna structure and the second point on the antenna structure correspond to diagonally opposite corners of the dielectric substrate.
